(19) United States
(12) Patent Application Publication
(10) Pub. No.: US 2012/0117067 A1
(43) Pub. Date: May 10, 2012

(54) METHOD AND APPARATUS FOR PROVIDING A RANGE ORDERED TREE STRUCTURE

(75) Inventors: Alexey Yakubovich, Buffalo Grove, IL (US); Yekesa Kosuru, Westford, MA (US)

(73) Assignees: NAVTEQ North America, LLC, Chicago, IL (US); Nokia Corporation, Espoo (FI)

(21) Appl. No.: 13/285,818

(22) Filed: Oct. 31, 2011

Related U.S. Application Data
(60) Provisional application No. 61/408,317, filed on Oct. 29, 2010.

(51) Int. Cl. G06F 17/30

(52) U.S. Cl. 707/737; 707/E17.014; 707/E17.044; 707/E17.002

(57) ABSTRACT

An approach is provided for creating a range ordered tree structure. A tree index platform determines one or more ranges for grouping one or more data objects of a key-value store. Next, the tree index platform determines to specify the one or more ranges in one or more respective index objects of a data structure. Then, the tree index platform determines to associate the data structure with the key-value store.

### RELATED APPLICATIONS

This application claims the benefit of the earlier filing date under 35 U.S.C. §119(e) of U.S. Provisional Application Ser. No. 61/408,317 filed Oct. 29, 2010, entitled “Method and Apparatus for Providing a Range Ordered Tree Structure,” the entirety of which is incorporated herein by reference.

### BACKGROUND

Service providers and device manufacturers (e.g., wireless, cellular, etc.) are continually challenged to deliver value and convenience to consumers by, for example, providing compelling network services. One area of development has been the creation of large stores or databases of information for use or access through such services. For example, a mapping service or application may rely on data stores containing millions or even trillions of data records containing information on map features such as points-of-interests, topography, terrain features, and the like. However, as the number of data records increase, service providers and device manufacturers face significant technical challenges to enabling efficient access and query of large information or data systems.

### SOME EXAMPLE EMBODIMENTS

Therefore, there is a need for an approach for providing an ordered tree structure (e.g., ordered based on ranges of data values or content) to facilitate querying and/or accessing data stores.

According to one embodiment, a method comprises determining one or more ranges for grouping one or more data objects of a data store. The method also comprises determining to specify the one or more ranges in one or more respective index objects of an index structure. The method further comprises determining to associate the index structure with the data store.

According to another embodiment, an apparatus comprises at least one processor, and at least one memory including computer program code, the at least one memory and the computer program code configured to, with the at least one processor, cause, at least in part, the apparatus to determine one or more ranges for grouping one or more data objects of a data store. The apparatus is also caused to determine to specify the one or more ranges in one or more respective index objects of an index structure. The apparatus is further caused to determine to associate the index structure with the data store.

According to another embodiment, a computer-readable storage medium carries one or more sequences of one or more instructions which, when executed by one or more processors, cause, at least in part, an apparatus to determine one or more ranges for grouping one or more data objects of a data store. The apparatus is also caused to determine to specify the one or more ranges in one or more respective index objects of an index structure. The apparatus is further caused to determine to associate the index structure with the data store.

According to another embodiment, an apparatus comprises means for determining one or more ranges for grouping one or more data objects of a data store. The apparatus also comprises means for determining to specify the one or more ranges in one or more respective index objects of an index structure. The apparatus further comprises means for determining to associate the index structure with the data store.

According to another embodiment, a method comprises facilitating access to at least one interface configured to allow access to at least one service, the at least one service configured to determine one or more ranges for grouping one or more data objects of a data store. The at least one service is also configured to determine to specify the one or more ranges in one or more respective index objects of an index structure. The at least one service is further configured to determine to associate the data structure with the data store.

According to another embodiment, a computer program product including one or more sequences of one or more instructions which, when executed by one or more processors, cause an apparatus to determine one or more ranges for grouping one or more data objects of a data store. The apparatus is also caused to determine to specify the one or more ranges in one or more respective index objects of an index structure. The apparatus is further caused to determine to associate the index structure with the data store.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a range ordered tree structure, according to one embodiment;

FIG. 2 is a diagram of the components of a tree index platform, according to one embodiment;

FIG. 3 is a flowchart of a process for creating a range ordered tree structure, according to one embodiment;

FIG. 4 is a flowchart of a process for balancing a range ordered tree structure, according to one embodiment;

FIG. 5 is a flowchart of a process for querying a range ordered tree structure, according to one embodiment;

FIG. 6 is a diagram of an example range-ordered tree structure, according to one embodiment;

FIG. 7 is a diagram of user interfaces used in the processes of FIGS. 3-5, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for providing a range ordered tree structure are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “data store” refers to one or more data structures for storing and retrieving data represented by physical phenomena. The data structure may be a single file, a file system, or a sophisticated database, such as a relational database, or any other arrangement of data. In some embodiments, the data store may be a distributed data store. By way of example, a “distributed data store” refers to multiple data structures spread over two or more nodes of a communications network, such as the Internet. To guard against node failure, entries in some distributed data stores are replicated on multiple nodes.

In one embodiment, the data store is a key-value store wherein each entry of the store is indexed by a key bound to a value or set of values (the key-value pair constitutes an entry, as used herein). For example, a user name serves as a key for a value that associated information such as user profile information including user contacts, photographs, music files, and other digital content. In a distributed data store, the key-value pairs are stored on, for instance, multiple nodes of a network with each entry (corresponding to each key) replicated on several nodes. Although various embodiments are discussed with respect to a key-value data store, it is contemplated that the embodiments of the approach described herein are applicable to a data store based on any type of data structure or representation.

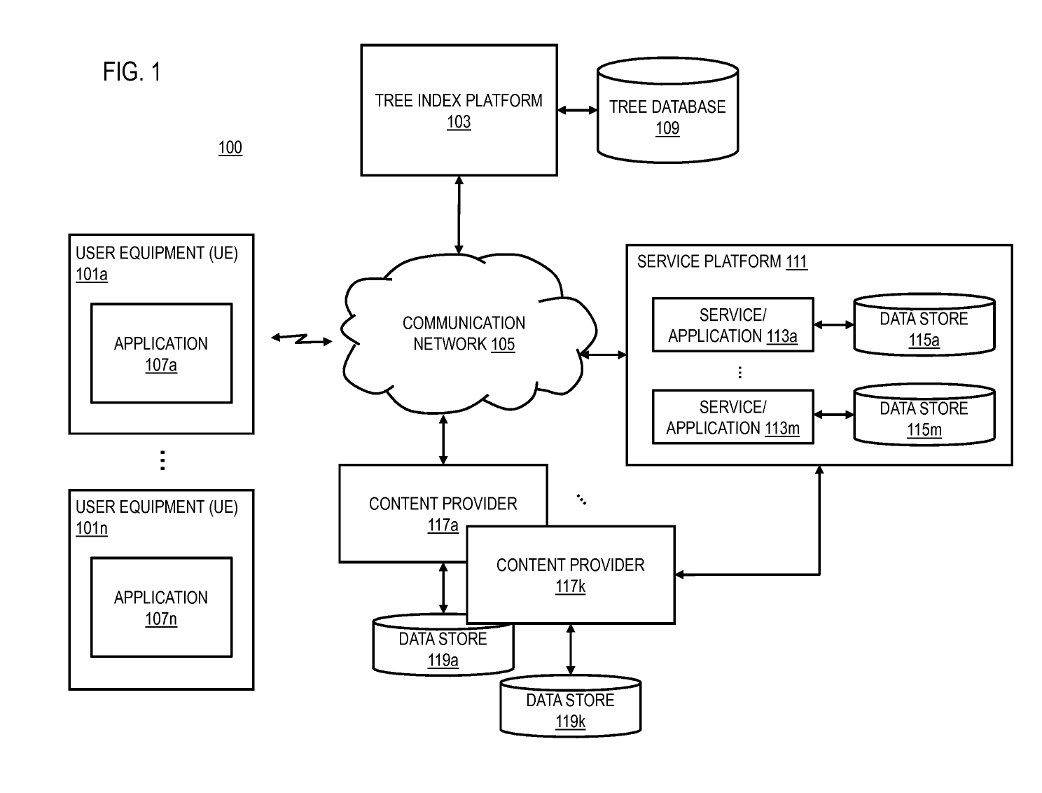

FIG. 1 is a diagram of a system capable of providing a range ordered tree structure, according to one embodiment. As previously mentioned, modern applications and services can often include accessing and/or managing large data stores or databases with potentially vast numbers of records. However, as the sizes of these data stores increase, it becomes more resource and time intensive to query, update, or otherwise manage the records (e.g., key-value pairs) within the data stores. Traditional approaches have sought to improve operational efficiency of large data stores by using a tree structure to arrange sorted or ordered data objects. For example, the B-tree, B+tree, and their variants are generally used to arrange sorted data (objects) in a way that allows for efficient insertion, retrieval, and/or removal of individual data records with the data stores. Typically, each of the records is identified in the tree structure by key (e.g., a unique identifier).

Another type of conventional tree structure is an R-tree. The R-tree is similar to a B-tree, but is used to operate on spatially related data, where the data records or objects include coordinates in an n-dimensional Euclidean space. An example of such objects is geo-tagged data that includes latitude/longitude coordinates (e.g., points of interest in a mapping service, geo-tagged images, tracking information, etc.). Under this traditional approach, R-tree related algorithms allow for implementing different types of queries (e.g., spatial queries) with conditions specified for location coordinates.

However, these traditional tree-structure approaches and related technologies rely on the assumption that the set of all data objects in the data stores is or can be totally ordered based on one or more specific parameters. Totally ordered, in this case, refers to whether all data records of in the data store include values for comparable parameters that can sorted or ordered. For example, a contact list that is arranged using a B-tree is typically sorted alphabetically before mapping the objects or records of the contact list to a B-tree. Moreover, queries and operations over traditional trees often are dependent on knowledge or viewing of the underlying objects of the data store and cannot generally be completed using the only the tree structure. Consequently, iterating over the objects of a large data store can be slowed as the objects are accessed and inspected as part of the completing a requested query or operation.

In addition, a common type of query that is often performed on the data store is a query wherein a range with respect to one or more parameters of the data objects is specified to conduct the query. For example, for a contact list, one range-based query may request all contacts whose birthdays fall between Jan. 1, 1970 and Jun. 30, 1971. Under the traditional approaches, even if the data objects may be ordered or sorted according to birthdays, the ranged query would nonetheless cause the query engine to iterate over a potentially responsive range of the data by accessing the data records and determining whether the records fall within the queried range. The accessing and inspecting of the data records can be resource and time intensive.

One conventional approach to supporting ranged searches is a Trie data structure used in, for instance, in Lucene. It is noted that Lucene is widely used for its full test searching and indexing capabilities. For this purpose, a Trie-based approach builds object keys from objects (e.g., most often text documents) for a predefined set of queries. For this purpose, Trie often specifies keywords and phrases that are extracted from the original data objects to build an index. Trie data structures often are based on predefined data formats, key words, searches, and ranges. However, for less structured or arbitrary data (e.g., general purpose key-value stores), Trie and/or Lucene have limited applicability.

To address this problem, a system 100 of FIG. 1 introduces the capability to provide a ranged ordered tree structure for accessing and managing data stores. In one embodiment, the system 100 defines a ranged object type that can be used to construct the range ordered tree structure and a corresponding ranged query for application to the range ordered tree structure to identify specific objects (e.g., data objects) of the data store. More specifically, in one embodiment, the system 100 defines an object type Obj which specifies object parameters p₁, p₂ . . . pₖ (comparable) and parameters q₁, q₂ . . . qₙ. Additionally, a query Q specifies conditions on values of parameters p₁, p₂ . . . pₖ, stating that those values are within ranges (v₁₁, v₁₂), (v₂₁, v₂₂) and alternatively some other conditions on other parameters. In this case, such a query Q is defined as a “ranged query” or R-query.

In one embodiment, the R-query can be based on a combination of different parameters and their corresponding ranges to define range intersections. The range interactions enable querying based on more complex conditions by combining multiple ranges and intersections. For example, a range intersection query can be used to express a spatial query like for the R-tree with the potential for overlaying additional conditions or parameters to formulate a more complicated or intricate query.

In another embodiment, the system 100 also defines the object type ObjR (e.g., a ranged object) that specifies parameters that form pairs:

| | |
|---|---|
| p₁₁, p₁₂ | of type Type1 |
| p₂₁, p₂₂ | of type Type2 |
| . . . | |

In one embodiment, the semantics of ObjR is such that each pair pₙ₁, pₙ₂ of type Typeᵢ specifies a range rₙ=(pₙ₁, pₙ₂) for the values of the same type. In one embodiment, the Typeᵢ can be of any comparable data or parameter type (e.g., numerical, string, coordinates, time, etc.). Accordingly, corresponding R-queries are not limited by any one data format and can be used to specify both numerical and string values. In this embodiment, such type ObjR is called a type kind with ranges, or just an R-kind object type (e.g., ranged object). In certain embodiments, any query for objects of the R-kind type would contain scalar values vₙ for each range (pₙ₁, pₙ₂), and fetch objects where the specified value fits into appropriate ranges.

In embodiments of the approach described herein, for a key-value store S, the system 100 defines a tree index structure T (e.g., a range ordered tree) and family of traversing algorithms that enable fetch objects that satisfy any ranged query for the time log(Card(S)) where Card(S) is a number of objects in store S. In one embodiment, objects in S can be an R-kind object type.

In one embodiment, the system 100 enables dynamic binding of the data objects with one or more nodes of the range ordered tree. In other words, the binding can be automatically updated as new objects are inserted, deleted, or otherwise modified in the key-value store S. In addition, it is contemplated that if the range ordered tree is implemented in a distributed environment, then the traversal of the range ordered can be implemented with parallel branching processes or threads).

As shown in FIG. 1, the system 100 comprises a user equipment (UE) 101 or multiple UEs 101a-101n (or UEs 101) having connectivity to a tree index platform 103 via a communication network 105. A UE 101 may include or have access to an application 107 (or applications 107), which consist of client programs, services, or the like that may utilize the system 100 to provide, manage, and/or access the functions of the tree index platform 103. As users access the applications 107 on their respective UEs 101, the tree index platform 103 may process information related to generating ranged ordered trees for storage in the tree database 109. As shown, the UEs 101 and the tree index platform 103 also have connectivity to a service platform 111 hosting one or more respective services/applications 113a-113m (also collectively referred to as services/applications 113) and their corresponding data stores 115a-115m (also collectively referred to as data stores 115). The UEs 101 and the tree index platform 103 also have connectivity to content providers 117a-115k (also collectively referred to as content providers 117) and their corresponding data stores 119a-119k (also collectively referred to as data stores 119). In one embodiment, the services/applications 113a-113m comprise the server-side components corresponding to the applications 107a-107n operating within the UEs 101. In one embodiment, the service platform 111, the services/applications 113a-113m, the application 107a-107n, or a combination thereof have access to, provide, deliver, etc. one or more items associated with the content providers 117a-117k and their data stores 119a-119k. In other words, content and/or items are delivered from the content providers 117a-117k to the applications 107a-107n or the UEs 101 through the service platform 111 and/or the services/applications 113a-113n.

In some cases, a developer of the services/applications 113a-113m and/or the applications 107a-107n may request that the tree index platform 103 generate one or more tree index structures (e.g., range ordered tree structure) associated with all or a portion of any of the data stores 115 and the data stores 119 with respect to content or items obtained from the content providers 115a-115k. In one embodiment, the tree index structures can be used to support processing ranged queries directed at any of the data stores 115 and/or 119. The developer may, for instance, transmit the request on behalf of the application 107 and/or the services/applications 113 to the tree index platform 103 for the purpose of defining data types for creating the ranged objects and/or ranged queries to create the tree index structures and binding the structures to the respective data stores 115 and/or 119. In one embodiment, the tree index structures may be stored in the tree database 109. In addition or alternatively, the tree index structures may be stored in the corresponding data stores 115 and/or 119 or other component of the communication network 105. After generating the tree index structures, the tree index platform 103 can receive or act on requests for performing a ranged query on the data stores 115 and/or 119.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the tree index platform 103, and the application 107, the service platform 111, and the content providers 117 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the application 107 and the corresponding service platform 111, services 113a-113m, the content providers 117a-117k, or a combination thereof interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

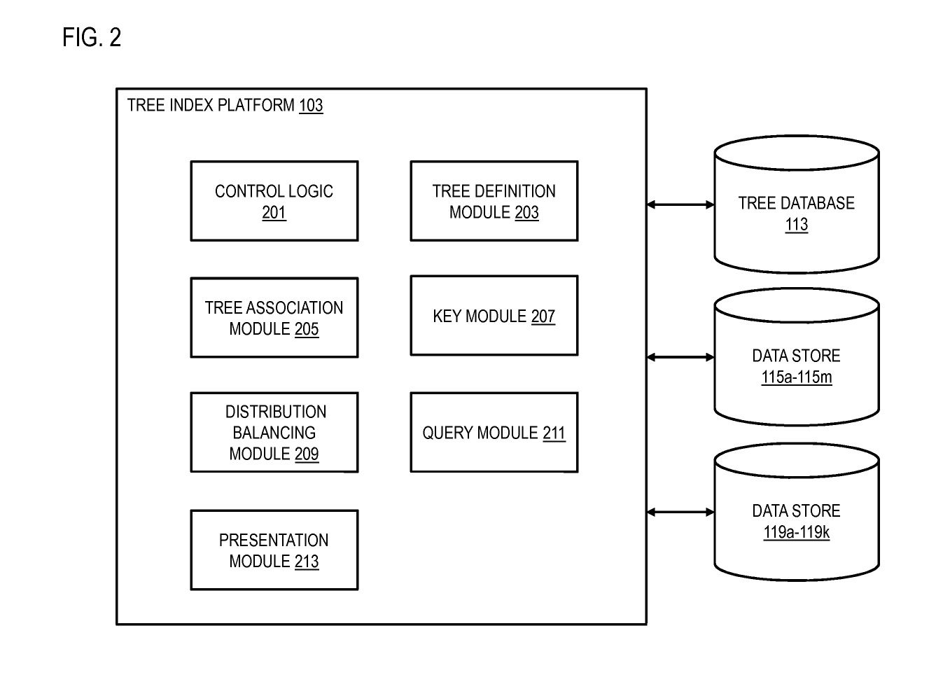

FIG. 2 is a diagram of the components of a recommendation platform, according to one embodiment. By way of example, the tree index platform 103 includes one or more components for providing a range ordered tree structure. It is contemplated that the functions of these components may be combined in one or more components or performed by other components of equivalent functionality. In this embodiment, the tree index platform 103 includes at least a control logic 201 which executes at least one algorithm for performing functions of the tree index platform 103. For example, the control logic 201 interacts with a tree definition module 203 to define, configure, and/or generate a range ordered tree structure (e.g., an index structure) for one or more data stores 115 and/or 119. In one embodiment, the tree definition module 203 determines the ranges to associate with index objects or nodes of the index structure, the number levels of the index structure, the data object parameters to include, and the like. In one embodiment, the index objects or nodes are ordered by parameter and then by range. In other words, the index structure itself is ordered. In this way, the data objects in the data store need not be totally ordered and may include non-comparable parameters (e.g., device model, device capabilities, color, etc.). In one embodiment, the tree definition module may store the index structure in the tree database 109.

After defining or creating the index structure, the control logic 201 interacts with the tree association module 205 to bind or otherwise associate data objects with the corresponding index objects of the index structure. In one embodiment, the binding occurs by linking one or more keys (e.g., primary keys used to uniquely identify a data object, and secondary keys used to encode additional parameters with the primary key). The functions of the tree index platform 103 related to key generation and management are performed by, for instance, the key module 207.

After binding of the index objects and data objects, the control logic 201 interacts with the distribution balancing module 209 to monitor the distribution patterns of the data objects over the index objects. For example, if one or more of the nodes has a significantly higher or lower load of associated objects, the distribution balancing module 209 can initiate a rebalancing of the affected nodes or the entire tree structure. More specifically, the distribution balancing module 209 can initiate a join operation to merge two or more index objects or a split operation to divide one index object into two or more resulting objects.

In one embodiment, the tree index platform 103 also includes a query module 211 for performing ranged queries over the data stores via an associated range ordered tree structure (e.g., an index structure). By way of example, the query module 211 include at least in part algorithms for describing and implementing ranged queries on objects with a combination of comparable scalar parameters and ranges of comparable parameters data stores (e.g., key-value stores). On completing a query, the query module 211 can interact with a presentation module 213 to present the results (e.g., responsive data objects from the data store) in a user interface.

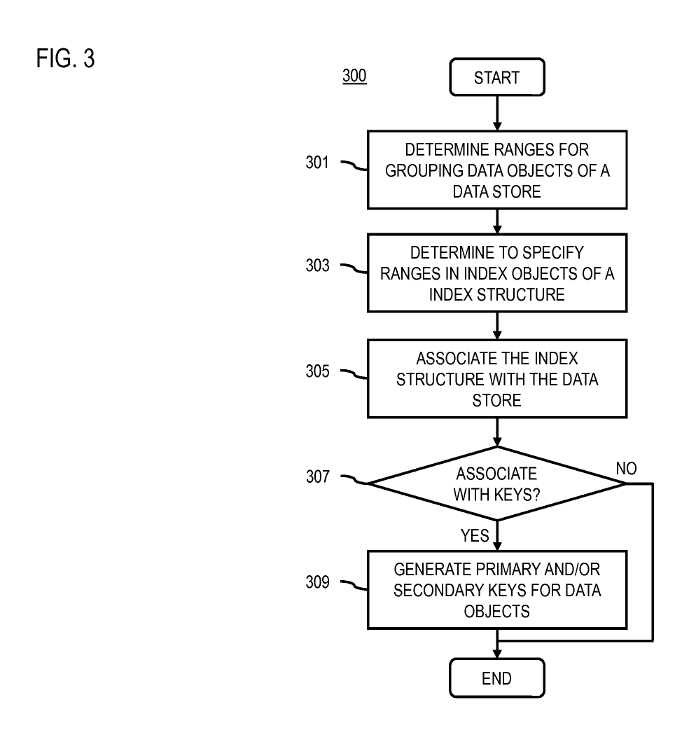

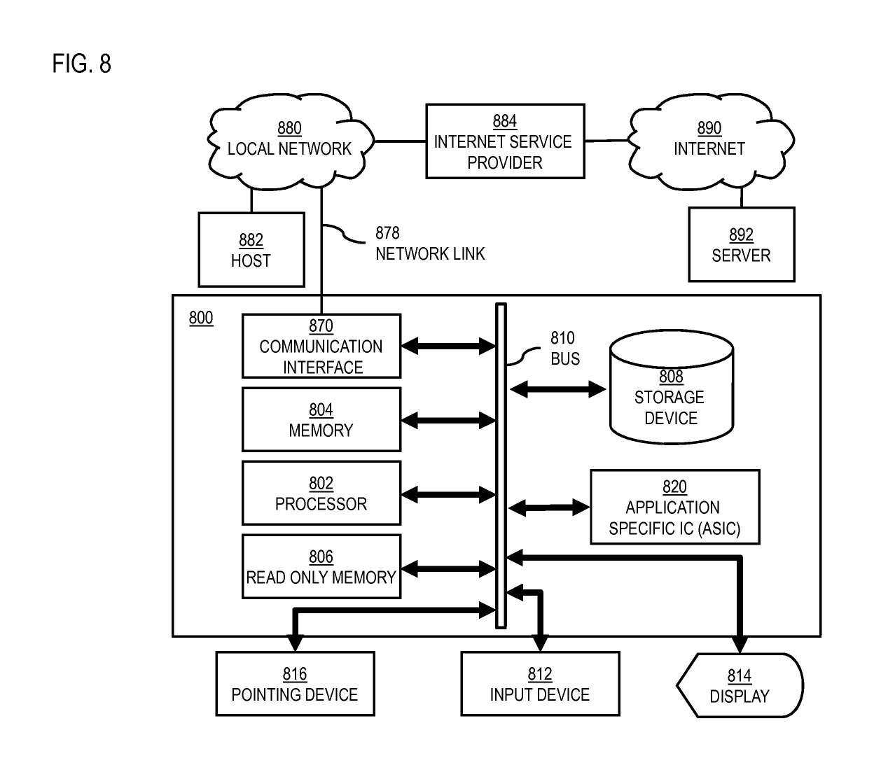

FIG. 3 is a flowchart of a process for creating a range ordered tree structure, according to one embodiment. In one embodiment, the tree index platform 103 performs the process 300 and is implemented in, for instance, a chip set including a processor and a memory as shown in FIG. 8. In step 301, the tree index platform 103 determines one or more ranges for grouping one or more data objects of a data store. In one embodiment, the one or more ranges are described with respect to one or more parameters associated with the one or more data objects. For example, a data object may represent a person and an example of a parameter can be body weight. Accordingly, the one or more ranges may represent intervals of body weight (e.g., 0-50 lbs, 50-100 lbs, 100-150 lbs, 150-200 lbs, etc.).

In one embodiment, the multiple ranges covering multiple parameters may be specified. For example, in addition to body weight, a range covering the person's age can be specified in addition to body weight. In another example, one range may relate to a latitude parameter for location coordinates and another range may relate to a longitude parameter for location coordinates. Accordingly, the intersection of the latitude and longitude ranges effectively queries the data objects based on location. In this way the intersection of the two multiple ranges can be used to perform more sophisticated or complex query and/or analysis of the data store.

The tree index platform 103 then determines to specify the one or more ranges in one or more respective index objects or nodes of an index structure (step 303). In one embodiment, the index structure is a tree structure and the one or more respective index objects are nodes of the tree structure. For example, specifying the one or more ranges means, at least in part, associating at least one of the ranges with a respective index object. In this way, only those data objects that fall substantially within the corresponding range are associated with or bound to the index object. In one embodiment, the different levels of the index tree structure can be associated with the different parameters of the one or more data objects. For example, the root level of the index structure may be based on a key parameter (e.g., a patient's name or ID), then each subsequent level of the structure can be associated with additional parameters. For instance, below the patient's name or ID at the root level may be assigned another comparable parameter such as last doctor's visit. It is contemplated the number levels to include in the hierarchy and the granularity of the range definitions can be determined by an information owner, service provider, content provider, network operator, and the like.

The tree index platform 103 then determines to associate the index structure with the data store (step 305). In one embodiment, the process for associating the index structure with the data store includes binding one or more keys associated with the data objects of the data store the corresponding index object or node of the index structure. If keys are used for association (step 307), the tree index platform 103 can either retrieve and/or generate any of the keys (step 309). In one embodiment, the one or more keys include one or more primary keys and/or one or more secondary keys. By way of example, the primary key is typically a unique identifier associated with a particular data object (e.g., a patient ID). The secondary key can then be generated from the primary key to encode information regarding one or more other related parameters (e.g., non-comparable parameters) describing the associated data object. In one embodiment, the secondary key is generated by applying a hash function on the primary key and the one or more other parameters. In this way, the secondary key can encode additional parameters that are otherwise not captured in the index structure.

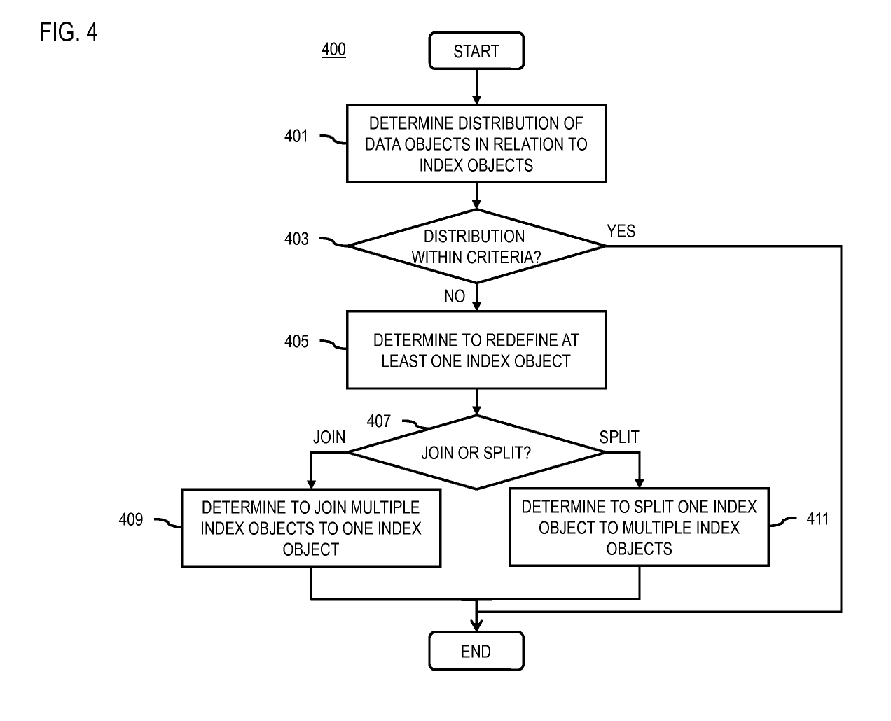

FIG. 4 is a flowchart of a process for balancing a range ordered tree structure, according to one embodiment. In one embodiment, the tree index platform 103 performs the process 400 and is implemented in, for instance, a chip set including a processor and a memory as shown in FIG. 8. The process 400 assumes that an index tree structure has been created and associated or bound to a data store as described with respect to the process 300 of FIG. 3. The binding, for instance, associates the individual data objects of a data store with the corresponding index objects or nodes of the index tree structure. In step 401, the tree index platform 103 determines a distribution of the one or more data objects in relation to the one or more respective index objects. By way of example, the determination can include observing or counting the number of data objects that are bound to each of the index nodes.

Based at least in part on the determined distribution, the tree index platform 103 then determine whether the distribution exceeds distribution criteria (e.g., a maximum standard or difference of the distribution among the nodes) (step 403). For example, if the standard deviation of the distribution is higher than a predetermined threshold, the tree index platform 103 may infer that the index nodes are not balance. In this case, the tree index platform 103 determines to redefine at least one of the one or more respective index objects based at least in part the distribution (step 405).

In one embodiment, the redefining process includes determining whether one or more of the respective index objects should be joined, split, or both (step 407). For example, if any one of the index objects is associated with or bound to a relatively higher number of data objects, the tree index platform 103 may determine to split the index object to make the distribution more even (step 411). In one embodiment, splitting includes dividing the range associated with the index object into two or more sub-ranges and then assigning each sub-range to its own index object.

Conversely, if two or more index objects are associated with or bound to a relatively low number of data objects, the tree index platform 103 merge the ranges specified or associated with the multiple index objects into a single index object (step 409). In some embodiments, the tree index platform 103 may employ a combination of splitting and joining at different ratios to achieve a more balanced distribution.

In one embodiment, the tree index platform 103 may perform the process 400 automatically on detection of an imbalance of the distribution of the data objects over the index objects. In another embodiment, the tree index platform 103 may rebalance all or a portion of the index structure. In other words, the tree index platform 103 may perform the rebalancing only on the subtrees or branches of the index structure that are not with the predetermined distribution criteria.

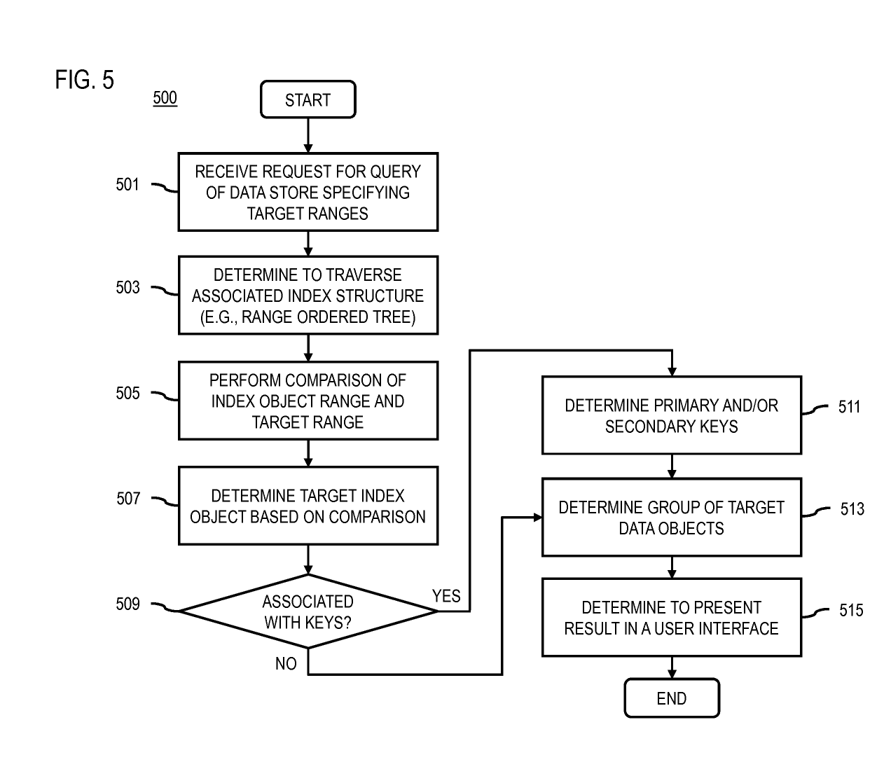

FIG. 5 is a flowchart of a process for querying a range ordered tree structure, according to one embodiment. In one embodiment, the tree index platform 103 performs the process 500 and is implemented in, for instance, a chip set including a processor and a memory as shown in FIG. 8. As with the process 400 of FIG. 4, the process 500 assumes that an index tree structure has been created and associated or bound to a data store as described with respect to the process 300 of FIG. 3. In step 501, the tree index platform 103 receives a request for performing a query of the data store, the query specifying at least in part one or more target ranges.

In response to the request, the tree index platform 103 determines to traverse the index structure to determine at least one of the one or more respective index objects based, at least in part, on the one or more ranges associated with the at least one respective index objects and the one or more target ranges (step 503). Under the various embodiments of the approach described herein, the traversal of the index structure occurs without accessing the data objects of the data store. Therefore, the index structure and associated data store are effectively independent with respect to the query process. Instead, the traversal is based, at least in part, on the ranges and parameters associated with the nodes and levels of the index structure. For example, during traversal, the tree index platform 103 performs a comparison of the one or more ranges and parameters associated with one or more of the index objects and the target ranges specified in the query request (step 505).

Based, at least in part, on the comparison, the tree index platform 103 determines the target index objects (e.g., the objects with ranges overlapping or falling with the target ranges) that are associated with data objects that are potentially responsive to the query (step 507). Next, the tree index platform 103 determines whether the binding between the index objects and the corresponding data objects are associated with keys (step 509). As discussed previously, the keys point to or reference corresponding one or more data objects in the data store. In step 511, the tree index platform 103 determines whether the binding is via primary keys (e.g., direct and unique identifiers of the corresponding data objects) and/or secondary keys (e.g., keys encoded using a hash function over the primary key and one or more parameters associated with the data object reference by the primary key).

Based on the keys, the tree index platform 103 then determines the actual data objects or group of data objects indicated by the keys (step 513). This group represents, for instance, the data objects that are responsive to ranged query. In some embodiments, the tree index platform 103 then determines to present the results (e.g., the determine data objects or group of data objects) in a user interface (step 515). In addition or alternatively, the tree index platform 103 may initiate transfer or delivery of the data objects or links to the data objects to the requesting device.

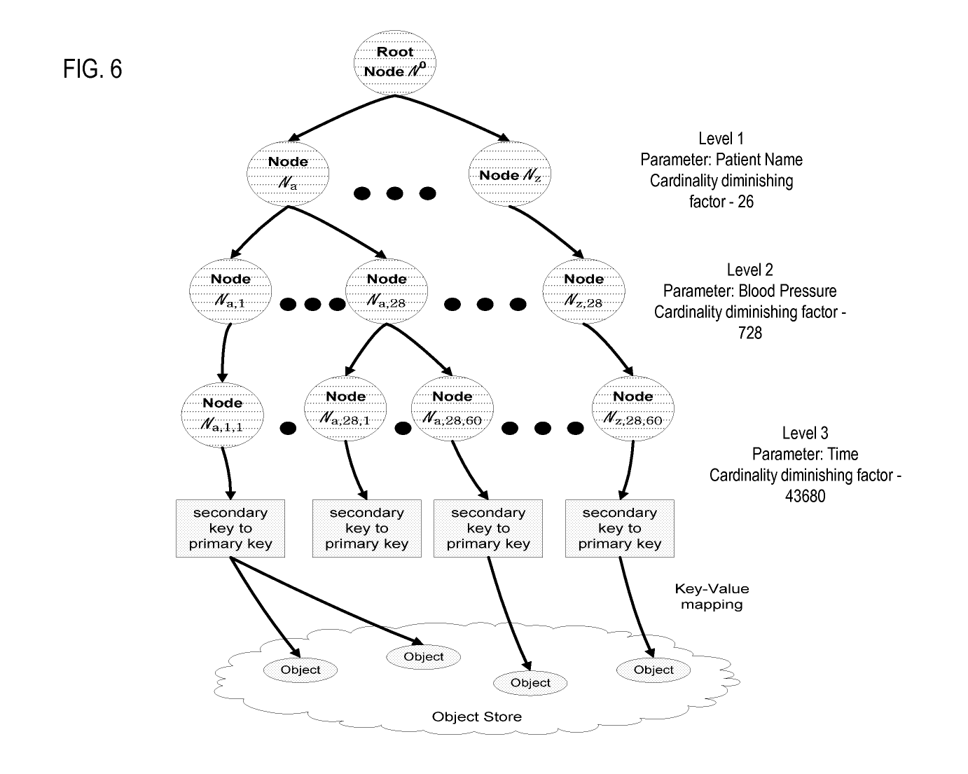

FIG. 6 is a diagram of an example range-ordered tree structure, according to one embodiment. In the example of FIG. 6, a key store S contains data objects with the following comparable parameters: patient name (string), blood pressure (double, positive) and time of measurement (double, within time interval 2005-2010) and other non-comparable parameters (blood type, medications). In this case, the inclusion of non-comparable parameters makes the store S not totally ordered. By way of example, the application 107 may construct one or more queries that specify a range for names (e.g., the several first letter of name), a range for blood pressure, and a time interval over which to conduct the query. In addition, the example denotes the cardinality of all objects (e.g., patients) in store S as Card(S). The key associated with the objects is, for instance, a unique patient ID.

In preparation for the one or more queries, the tree index platform 103 builds the range ordered tree T for the key-value store S by first designating that the level 0 (zero) contains a single root node N₀. For level 1, the tree index platform 103 breaks the interval of all values for patient names into 24 groups according to the first few letters of the names. It is noted that the intervals can be defined to ensure a substantially even distribution of the data objects among the nodes. For example, the interval need not be defined on a letter by letter basis (e.g., one interval per letter of the alphabet). Instead, individual letters may be combined (e.g., X, Y, and Z may be placed together into one interval) or split (e.g., A may be split into Aa-Ac, Ad-An, and Ao-Az).

In this example, the letters X, Y, and Z are combined into one interval. In this there is no combination or split. Accordingly, the tree index platform 103 defines 26 nodes (e.g., one node or interval for each letter of the alphabet) at the first level as nodes Nₐ-N_{z}: each node will refer to the patients with names starting from the corresponding letter.

For each first level node, the tree index platform 103 adds 28 second level nodes covering corresponding blood pressure ranges: less than 40, 40-50, . . . , 290-300, more than 300. Those nodes are named N_{a,m} where first index a corresponds to one of the 26 letter intervals, and second index m presents the blood pressure interval, m=1, . . . , 28 (1 used for interval (0-40), . . . , 28 used for interval (300, ∞)). For each node N_{a,m}, the tree index platform 103 defines 60 new nodes, N_{a,m,p} where the third index p represents the month time interval between 2005 and 2010, p=1, . . . , 60. So, the tree index platform 103 has constructed 26*28*60=43680 leaf nodes in the range ordered tree T. If ranges uniformly break all collection of objects in store S, we would have equal number of objects per node, therefore Card(S)/43680 objects per leave node.

After constructing the range ordered tree T, the tree index platform 103 receives a ranged query Q specifying the following query ranges or parameters:
patient name start with “Jo S”
blood pressure between 215 and 245
measurement time between 12/2006 and 3/2007

The tree index platform 103 then traverses the range ordered tree T:
node Nⱼ on the first level (name starts from J)
two nodes N_{j,19}, N_{j,20} on the second level (blood pressure within 19 and 20 intervals)
four nodes N_{j,19,24}, N_{j,19,25}, N_{j,20,24}, N_{j,20,25} on the third level

All objects from the store that satisfy the query Q are attached to the four nodes specified above. So using the range ordered tree T, we reduced the set of Card(S) objects to the set which contains approximately 10000 less objects, representing a significant drop in the original number objects (e.g., 43680 objects).

If the query Q specifies conditions on other parameters, the tree index platform 103 now can, e.g., use a simple hash table to map a secondary key built from those other parameters to the primary object keys (patent ID). In one embodiment, the range ordered tree T is essentially an index structure that exists outside of key-value store so that the range ordered tree T can be traversed without looking up or inspecting the corresponding data object in the store S.

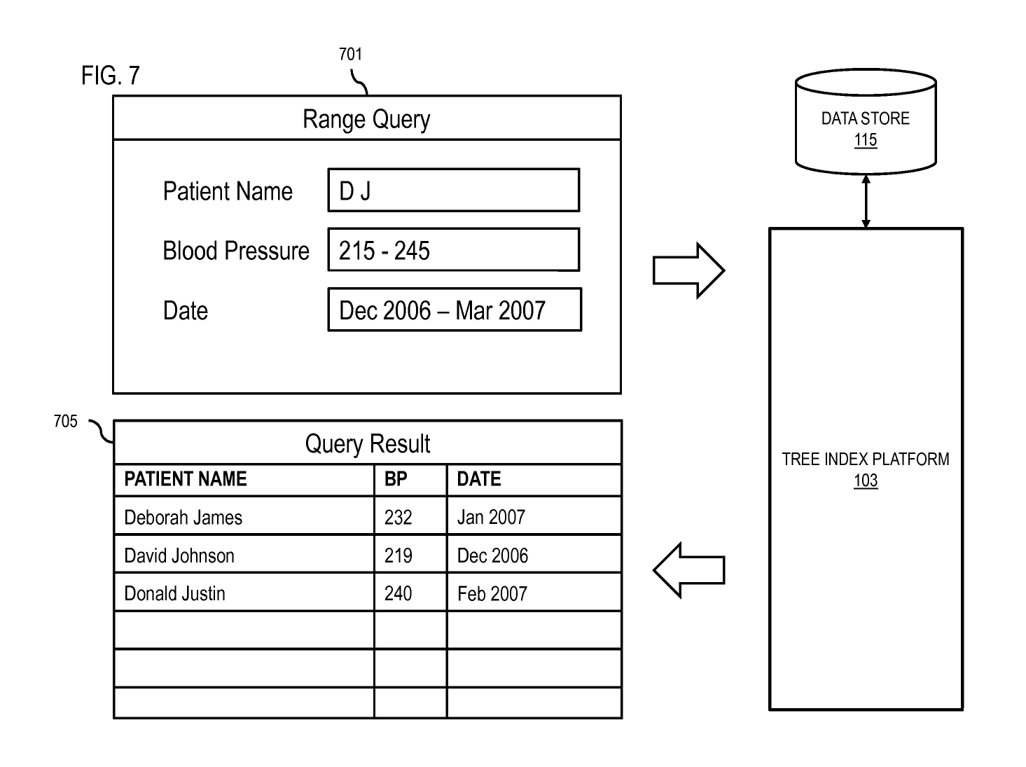

FIG. 7 is a diagram of user interfaces used in the processes of FIGS. 3-5, according to one embodiment. More specifically, FIG. 7 depicts a user interface (UI) 701 that presents, for instance, an input screen for specifying a ranged query. As shown, a user has selected to create a ranged query based on three parameters: patient name, blood pressure, and date interval. It is contemplated that the UI 701 can support any means of interacting with the user (e.g., touch-based input, traditional keypad or keyboard input, voice input, handwriting recognition, etc.). In this example, the query is directed to a data store 115.

The tree index platform 103 receives the input and processes the query against a range ordered tree index structure associated with the data store 115 to identify objects that at least substantially satisfy the input criteria. The objects are presented in the UI 705 that lists three query results. In one embodiment, the results are presented at a user device (e.g., a smartphone, cell phone, portable computer, and the like).

The processes described herein for providing a range ordered tree structure may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to provide a range ordered tree structure as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of providing a range ordered tree structure.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to providing a range ordered tree structure. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for providing a range ordered tree structure. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing a range ordered tree structure, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for providing a range ordered tree structure.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

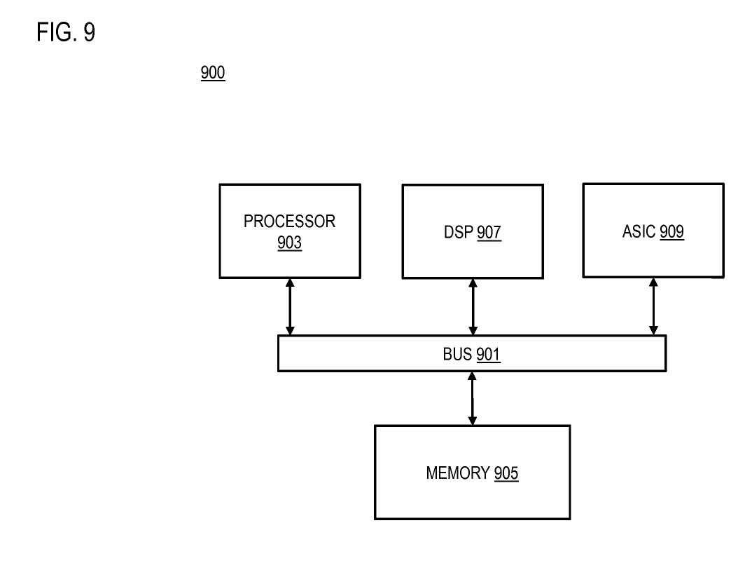

FIG. 9 illustrates a chip set or chip 900 upon which an embodiment of the invention may be implemented. Chip set 900 is programmed to provide a range ordered tree structure as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of providing a range ordered tree structure.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide a range ordered tree structure. The memory 905 also stores the data associated with or generated by the execution of the inventive steps.

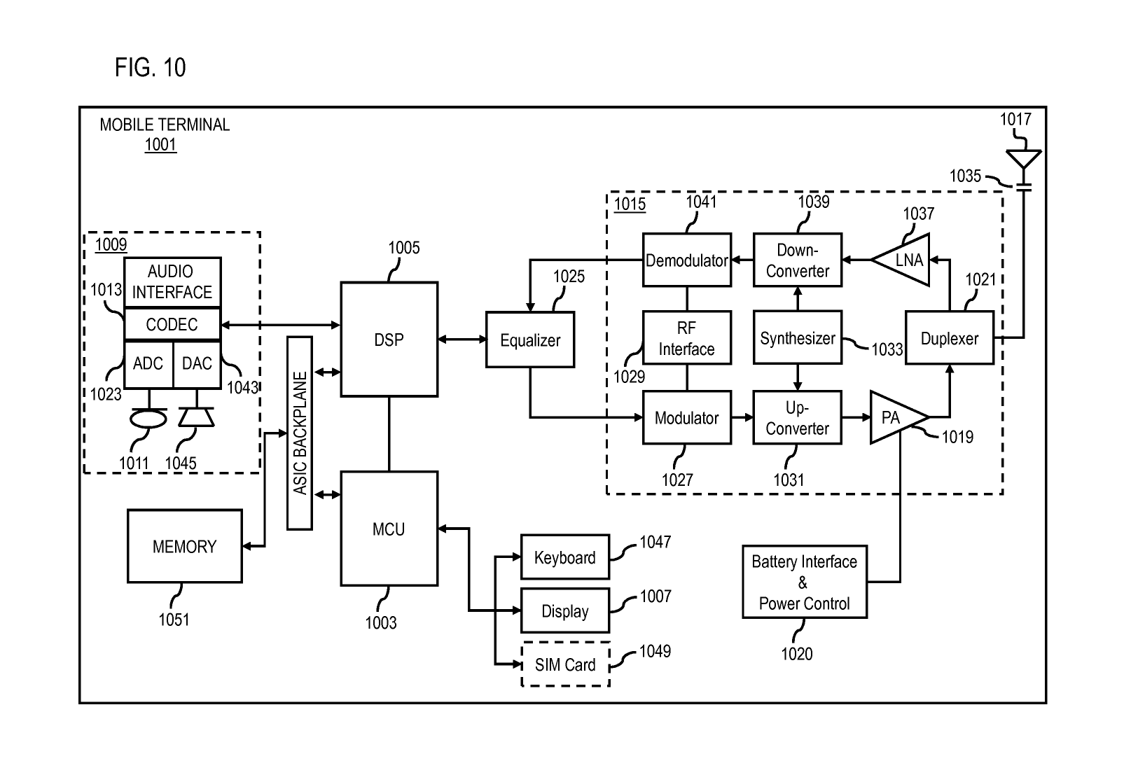

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of providing a range ordered tree structure. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of providing a range ordered tree structure. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to provide a range ordered tree structure. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
one or more ranges for grouping one or more data objects of a data store;
at least one determination to specify the one or more ranges in one or more respective index objects of an index structure; and
at least one determination to associate the index structure with the data store.

2. A method of claim 1, wherein the (1) data and/or (2) information and/or (3) at least one signal are further based, at least in part, on the following:
at least one determination to order the one or respective index objects based, at least in part, on the one or more ranges,
wherein the one or more ranges are described with respect to one or more parameters associated with the one or more data objects.

3. A method of claim 2, wherein the index structure is a tree structure and the one or more respective index objects are nodes of the tree structure.

4. A method of claim 2, wherein the one or more parameters are associated with respective levels of the tree structure.

5. A method of claim 1, wherein the (1) data and/or (2) information and/or (3) at least one signal are further based, at least in part, on the following:
a request for performing a query of the data store, the query specifying at least in part one or more target ranges; and
in response to the request, at least one determination to traverse the index structure to determine at least one of the one or more respective index objects based, at least in part, on the one or more ranges associated with the at least one respective index objects and the one or more target ranges.

6. A method of claim 5, wherein the (1) data and/or (2) information and/or (3) at least one signal are further based, at least in part, on the following:
at least one determination of a group of the one or more data objects based, at least in part, on the at least one respective index object; and
at least one determination to provide the group as a result of the query.

7. A method of claim 5, wherein the (1) data and/or (2) information and/or (3) at least one signal are further based, at least in part, on the following:
at least one determination to present the result in a user interface.

8. A method of claim 5, wherein the (1) data and/or (2) information and/or (3) at least one signal are further based, at least in part, on the following:
one or more keys associated with the at least one respective index object;
wherein the at least one determination of the group of the one or more data objects is based, at least in part, on the one or more keys.

9. A method of claim 8, wherein the one or more keys include one or more primary keys, one or more secondary keys, or a combination thereof

10. A method of claim 9, wherein one or more secondary keys are generated by applying a hash function on the one or more primary keys, one or more parameters associated with the one or more objects, or a combination thereof.

11. A method of claim 1, further comprising:
determining a distribution of the one or more data objects in relation to the one or more respective index objects;
determining a comparison of the distribution against predetermined criteria;
determining to rebalance at least one of the one or more respective index objects based at least in part the distribution, the comparison, or a combination thereof.

12. A method of claim 11, wherein the rebalancing of the at least one of the one or more respective index objects occurs in substantially real-time without user intervention.

13. A method of claim 11, wherein the determining to redefine the at least one respective index object comprises at least one of:
determining to join a plurality of the one or more respective index objects into the at least one respective index object; and
determining to split the at least one respective index object.

14. An apparatus comprising:
at least one processor; and
at least one memory including computer program code for one or more programs, the at least one memory and the computer program code configured to, with the at least one processor, cause the apparatus to perform at least the following,
determine one or more ranges for grouping one or more data objects of a data store;
determine to specify the one or more ranges in one or more respective index objects of an index structure; and
determine to associate the index structure with the data store.

15. An apparatus of claim 14, wherein the apparatus is further caused to:
determine to order the one or respective index objects based, at least in part, on the one or more ranges,
wherein the one or more ranges are described with respect to one or more parameters associated with the one or more data objects.

16. An apparatus of claim 14, wherein the apparatus is further caused to:
receive a request for performing a query of the data store, the query specifying at least in part one or more target ranges; and
in response to the request, determine to traverse the index structure to determine at least one of the one or more respective index objects based, at least in part, on the one or more ranges associated with the at least one respective index objects and the one or more target ranges.

17. An apparatus of claim 16, wherein the apparatus is further caused to:
determining a group of the one or more data objects based, at least in part, on the at least one respective index object; and
determining to provide the group as a result of the query.

18. A method comprising facilitating access to at least one interface configured to allow access to at least one service, the at least one service configured to perform at least the following:
determining one or more ranges for grouping one or more data objects of a data store;
determining to specify the one or more ranges in one or more respective index objects of an index structure; and
determining to associate the index structure with the data store.

19. A method of claim 18, wherein the at least one service is configured to further perform:
determining to order the one or respective index objects based, at least in part, on the one or more ranges,
wherein the one or more ranges are described with respect to one or more parameters associated with the one or more data objects.

20. A method of claim 18, wherein the at least one service is configured to further perform:
receiving a request for performing a query of the data store, the query specifying at least in part one or more target ranges; and
in response to the request, determining to traverse the index structure to determine at least one of the one or more respective index objects based, at least in part, on the one or more ranges associated with the at least one respective index objects and the one or more target ranges.
